(19) United States
(12) Patent Application Publication
(10) Pub. No.: US 2024/0381489 A1
(43) Pub. Date: Nov. 14, 2024

(54) MEDIA DATA PROCESSING METHOD AND MEDIA DATA PROCESSING DEVICE

(71) Applicant: LG ELECTRONICS INC., Seoul (KR)

(72) Inventors: Huisang YOO, Seoul (KR); Gyoyoon LEE, Seoul (KR); Jinpil KIM, Seoul (KR)

(73) Assignee: LG ELECTRONICS INC., Seoul (KR)

(21) Appl. No.: 18/580,819

(22) PCT Filed: Aug. 12, 2021
(86) PCT No.: PCT/KR2021/010707

§ 371 Date: Jan. 19, 2024

(51) Int. Cl. H04W 76/40; H04W 56/00

(52) U.S. Cl. CPC H04W 76/40; H04W 56/0015

(57) ABSTRACT

A media data processing method according to embodiments may comprise the steps of: receiving a signal including multicast data on the basis of a network, wherein the network includes an Internet protocol (IP) network, the signal includes a packet containing multicast data, and the packet includes signaling information for the multicast data; decoding the signaling information; parsing the multicast data; parsing a file from the packet; parsing announcement information associated with the multicast data from the packet; and synchronizing service data of the multicast data on the basis of the multicast data and the file.

### TECHNICAL FIELD

Embodiments relate to a method and device for transmitting media including a plurality of packets to a plurality of users in various ways.

### BACKGROUND ART

Receiver technology for 5G broadcast services in communication networks, e.g., 3GPP, is required.

Communication network-based broadcasting, e.g., 5G broadcast technology is related to the multimedia broadcast and multicast service standard technologies that are under development by 3GPP.

Protocols applicable to both Internet and broadcast networks are required for the transmission of large amounts of data packets to multiple users.

### DISCLOSURE

### Technical Problem

Embodiments provide a device and method for efficiently processing media. Embodiments provide a media data processing method and a media data processing device that allow high-quality media content to be efficiently transmitted over multiple paths with low latency.

The technical scope of the embodiments is not limited to the aforementioned technical objects, and may be extended to other technical objects that may be inferred by those skilled in the art based on the entire contents disclosed herein.

### Technical Solution

To achieve these objects and other advantages and in accordance with the purpose of the disclosure, as embodied and broadly described herein, a device for processing media data may include a receiver configured to receive a signal containing multicast data based on a network, wherein the network may include an Internet Protocol (IP) network, and the signal may contain a packet containing the multicast data, the packet containing signaling information related to the multicast data, a signaling decoder configured to decode the signaling information, a streaming service parser configured to parse the multicast data, a download service parser configured to parse a file from the packet, a parser configured to parse announcement information related to the multicast data from the packet, and a component synchronizer configured to synchronize service data of the multicast data based on the multicast data and the file.

In another aspect of the present disclosure, a method of processing media data may include receiving a signal containing multicast data based on a network, wherein the network may include an Internet Protocol (IP) network, and the signal may contain a packet containing the multicast data, the packet containing signaling information related to the multicast data, decoding the signaling information, parsing the multicast data, parsing a file from the packet, parsing announcement information related to the multicast data from the packet, and synchronizing service data of the multicast data based on the multicast data and the file.

### Advantageous Effects

According to embodiments, high-definition media content may be transmitted. According to embodiments, real-time live broadcasting may be processed. Embodiments may integrate high-definition mobile broadcasting and communication technologies. Embodiments may provide in-vehicle video/audio entertainment channel and data information services. Embodiments may provide technology that interoperates with 5G Core infrastructure. Embodiments may handle multi-pass streaming services. Embodiments may optimize video delivery paths.

### DESCRIPTION OF DRAWINGS

The accompanying drawings, which are included to provide a further understanding of the disclosure and are incorporated in and constitute a part of this application, illustrate embodiment(s) of the disclosure and together with the description serve to explain the principle of the disclosure. For a better understanding of various embodiments described below, reference should be made to the description of the following embodiments in connection with the accompanying drawings. The same reference numbers will be used throughout the drawings to refer to the same or like parts. In the drawings:

FIG. 1 illustrates an example multimedia broadcast and multicast service structure according to embodiments.

FIG. 2 illustrates an example MBMS network architecture model according to embodiments;

FIG. 3 illustrates an MBMS functional layer structure according to embodiments;

FIG. 4 illustrates a communication network broadcast transmission/reception model structure according to embodiments;

FIG. 5 is a flowchart of MBMS multicast service provision and MBMS broadcast service provision according to embodiments;

FIG. 6 illustrates a reception device structure of a communication network broadcast system according to embodiments;

FIG. 7 illustrates a communication network broadcast protocol stack according to embodiments;

FIG. 8 illustrates an MBMS reception device of a communication network broadcast reception device according to embodiments;

FIGS. 9 and 10 illustrate an MBMS file delivery workflow of a communication network broadcast receiver according to embodiments;

FIGS. 11 and 12 illustrate an MBMS media streaming workflow of a communication network broadcast receiver according to embodiments;

FIG. 13 illustrates how a network broadcast receiver operates according to embodiments;

FIG. 14 illustrates a structure of a media data transmission/reception device according to embodiments; and

FIG. 15 illustrates a media data processing method according to embodiments.

### BEST MODE

Reference will now be made in detail to the preferred embodiments of the present disclosure, examples of which are illustrated in the accompanying drawings. The detailed description, which will be given below with reference to the accompanying drawings, is intended to explain exemplary embodiments of the present disclosure, rather than to show the only embodiments that may be implemented according to the present disclosure. The following detailed description includes specific details in order to provide a thorough understanding of the present disclosure. However, it will be apparent to those skilled in the art that the present disclosure may be practiced without such specific details.

Although most terms used in the present disclosure have been selected from general ones widely used in the art, some terms have been arbitrarily selected by the applicant and their meanings are explained in detail in the following description as needed. Thus, the present disclosure should be understood based upon the intended meanings of the terms rather than their simple names or meanings.

Embodiments include a media data transmission method/device and a media data reception method/device, and the transmission/reception method/device may be referred to as a media data processing method/device for short.

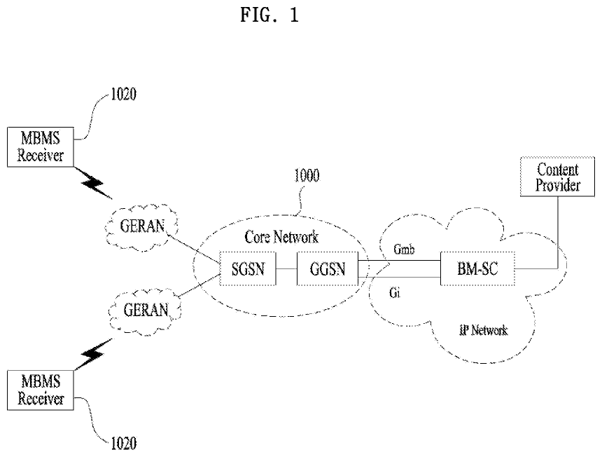

FIG. 1 illustrates an example multimedia broadcast and multicast service structure according to embodiments.

FIG. 1 illustrates a GPRS-based MBMS network architecture model for a media data processing method/device according to embodiments.

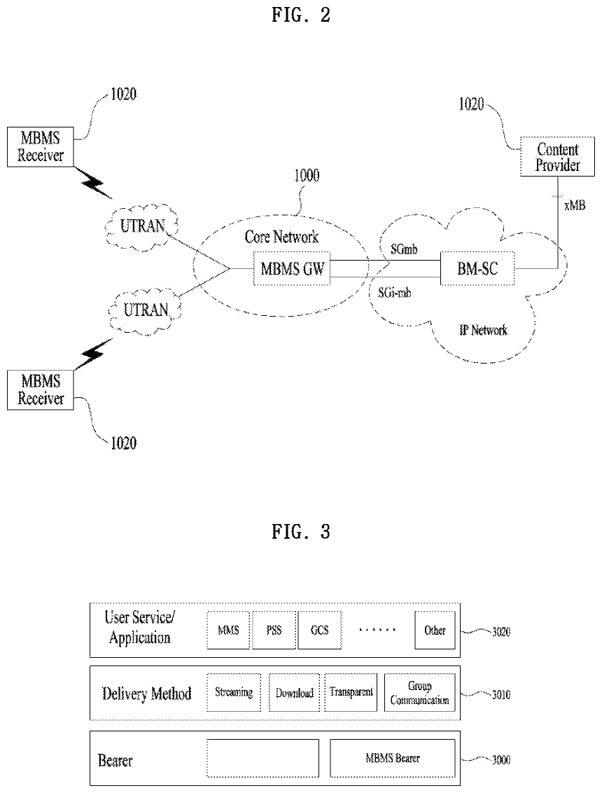

The media data processing device according to the embodiments may correspond to an MBMS receiver 1020. Further, the media data processing device according to the embodiments may correspond to a processor, a content provider 1010, and the like for a core network 1000. The media data processing device may correspond to the embodiments of FIGS. 2, 4, 6, 8, 11, and 12.

The multimedia broadcast/multicast service (MBMS) (standard technology includes a service method for transmitting a large number of data packets to multiple users at the same time based on IP multicast. One of the audio/video (A/V) transmission methods that can be commonly applied to broadcasting networks and Internet networks is the use of file-based multimedia content to create, process, transmit, and consume media data because it has excellent scalability and is not dependent on transmission protocols. Thus, it is widely used in the form of a download method through the existing Internet network. In addition, since the Content Delivery Protocol allows transmission over broadcast networks, it has sufficient potential as a common protocol that can be applied to both Internet networks and broadcast networks.

A similar existing technology to the MBMS is the cell broadcast service (CBS) technology. This technology also provides a service that can transmit a large number of data packets to multiple users at the same time. However, the data packet transmission speed is low and insufficient to transmit various multimedia data packets. The MBMS technology, on the other hand, is applicable to high-speed multimedia data packet transmission due to its significant improvement in data packet transmission speed.

Another difference is that the CBS is not an IP-based packet transmission technology, while the MBMS configures packets based on IP multicast. Compared to the case of transmission from a terminal receiver in the same cell to individual users over frequency networks that are separately allocated to the users, the resources required at the same time are saved, which in turn allows a large number of ordinary users to receive the same multimedia data, improving the efficiency of resources and providing users with low-cost access to multimedia services. Globally, MBMS services have been launched based on LTE Release 8. Currently, 3GPP Release 16 includes features to further enhance LTE.

The media data processing method/device according to embodiments relates to a receiver and a reception method for receiving and consuming multimedia content and various additional data services in a communication network broadcast (5G broadcast) environment.

With regard to the 5G broadcast system according to embodiments, the eMBMS technology may include 3GPP Release 9. Related technologies continue to evolve as standards evolve based on the Release 6-related multimedia broadcast & multicast service (MBMS).

According to embodiments, the MBMS may support the simultaneous delivery of data for streaming, file downloads, etc. to a large number of terminals over a 3G network. Unlike the eMBMS, which only supports broadcast transmission techniques, the MBMS technology is designed to support multicast transmission techniques, which allow data to be selectively transmitted to a specific number of terminals at the same time.

However, the MBMS technology had limitations in network performance at the time, and the service that allowed users to consume multimedia content through mobile terminals was not widely and universally available among terminal users.

The MBMS technology according to embodiments is capable of transmitting the same data to an unspecified number of users over the LTE core network based on the broadcast technique, which is a point-to-multi transmission method, and may be referred to as “LTE broadcast”.

Unlike the unicast transmission method, which is a point-to-point transmission method of mobile communications according to embodiments, the broadcast method transmits data in a point-to-multi manner, thereby increasing network efficiency.

In other words, the MBMS technology allows multiple users to receive the same multimedia data at the same point in time, thereby providing the service without any additional load caused by an increase in the number of terminals present in the same cell.

According to embodiments, the MBMS technology is applicable to a variety of services, including live event broadcasting in various specific regions, such as sports, concerts, and award ceremonies; SW update of mobile TV, IoT, and connected cars; SW update of terminals and applications using idle time; real-time information delivery to customers in a specific space; and data offloading.

In the case of content delivery protocols, multimedia content based on the MPGE standard has the limitation that there is a delay in the real-time aspect from the time the content is created and transmitted to the time the content is consumed on the terminal. To address this issue, methods such as progressive download and dynamic adaptive streaming over HTTP (DASH) have recently emerged to complement the real-time service of file-based content. However, due to the lack of a transmission protocol allowing files to be partitioned and consumed, the real-time service is still not good in conventional real-time streaming protocols such as MPEG-2 Transport Stream (TS) and Real Time Protocol (RTP).

The media data processing method/device according to embodiments may provide a content delivery protocol for MBMS transmission.

Embodiments relate to a content delivery method for providing multimedia content and various additional data services in a 5G broadcast environment, and a media data processing method/device for consuming that content.

The media data processing method/device according to embodiments may satisfy the following technical requirements for content services using a communication network, e.g., an LTE/5G communication network. For example, it may provide a transmission method for high-definition media content, a technology for real-time live broadcasting, a technology for convergence and interconnection of high-definition mobile broadcasting and communication technologies, a technology for in-vehicle video/audio entertainment channels and data information services, a technology for interconnection with 5G core infrastructure, a multi-pass streaming service, and/or an optimal transmission service for video delivery paths.

### 1. MBMS System Configuration According to Embodiments

The media data processing method/device according to embodiments may process media data based on a network structure as shown in FIG. 1.

The MBMS structure according to the embodiments may include a core network 1000, a content provider 1010, and an MBMS receiver 1020.

The core network 1000 may be connected to the MBMS receiver 1020 based on a wireless network. The wireless network according to the embodiments may include GERAN and UTRAN.

The core network 1000 may include a serving GPRS support node (SGSN) and a GGSN. The SGSN is a node matched to a wireless access network and responsible for packet call processing, session management, and mobility management. The GGSN is a gateway node in the GPRS packet network responsible for session and mobility management.

For example, the network structure according to the embodiments may include an MBMS network architecture based on the general packet radio service.

The core network 1000 and the content provider 1010 may be connected based on an IP network.

A broadcast multicast service centre (BM-SC) may be connected to the content provider 1010 to perform provisioning and delivery in order to provide an MBMS service to the receivers. In addition, the media data processing method/device according to the embodiments transmits an IP multicast packet through the Gmb and Gi interfaces and manages an MBMS bearer session.

FIG. 2 illustrates an example MBMS network architecture model according to embodiments.

FIG. 2 may correspond to the architecture of FIG. 1. FIG. 2 illustrates an evolved packet system (EPS)-based MBMS network architecture model for the media data processing method/device according to the embodiments.

The media data processing method/device according to the embodiments may correspond to the MBMS receiver 1020. Further, the media data processing device according to the embodiments may correspond to a processor for the core network 1000, the content provider 1010, and the like. It may correspond to the media data processing device of FIGS. 1, 4, 6, 8, 11, and 12.

The core network 1000 and the content provider 1010 may be connected based on an IP network.

The broadcast multicast service centre (BM-SC) may handle provisioning and delivery with the content provider 1010 to provide the MBMS service to the receiver. The media data method/device according to the embodiments transmits IP multicast packets over the SGmb and SGi-mb interfaces and manages MBMS bearer sessions. The core network 1000 may include a separate gateway for the MBMS service.

The core network 1000 may be connected to the MBMS receiver 1020 based on a network. The network according to the embodiments may include, for example, UTRAN and E-UTRAN.

FIG. 3 illustrates an MBMS functional layer structure according to embodiments.

The media data processing method/device according to the embodiments may be implemented on the network architecture of FIGS. 1 and 2 based on a protocol layer as shown in FIG. 3.

### 2. MBMS Functional Layer Structure

The MBMS-based service according to the embodiments may be configured in a three-layer structure, including a bearer layer 3000, a delivery layer 3010, and a user service layer 3020.

The bearer 3000 may provide a mechanism for transmitting IP data. The bearer may include a unicast bearer and an MBMS bearer.

The delivery method 3010 provides file restoration using forward-error-correction technology, and provides functions for key value transmission for security and network reliability control. The delivery method may include streaming, download, transparency, and group communication.

The user service layer 302 provides various application services and uses the delivery method for this purpose. The application services may include services such as multimedia messaging service (MMS), packet-switched streaming service (PSS), and group communication service (GCS).

### 3. MBMS Operation Mode

The MBMS operation mode of the media data processing method/device according to embodiments may include a multicast mode and a broadcast mode. The multicast mode is a method in which one or more transmitters transmit data to one or more specific receivers, and the broadcast mode is a method in which one transmitter transmits data to all receivers present in the same sub-network.

In the multicast mode, users should be allowed to communicate information about their billing and payment with the network operator, and should be allowed to individually register and unsubscribe to receive large amounts of data, such as multimedia streaming, based on their content consumption needs. Users should be allowed to confirm their willingness to pay for certain services and to join and leave groups. The capability to send data only to a specific area based on the information about the user's location is also required.

In the broadcast mode, regardless of the user's content consumption needs, the network operator transmits a large amount of multimedia data to a specific area based on the information about the locations of users, and the users receive the multimedia data using the receivers at the same time, such that streaming services are provided. Users are not charged for consuming multimedia data.

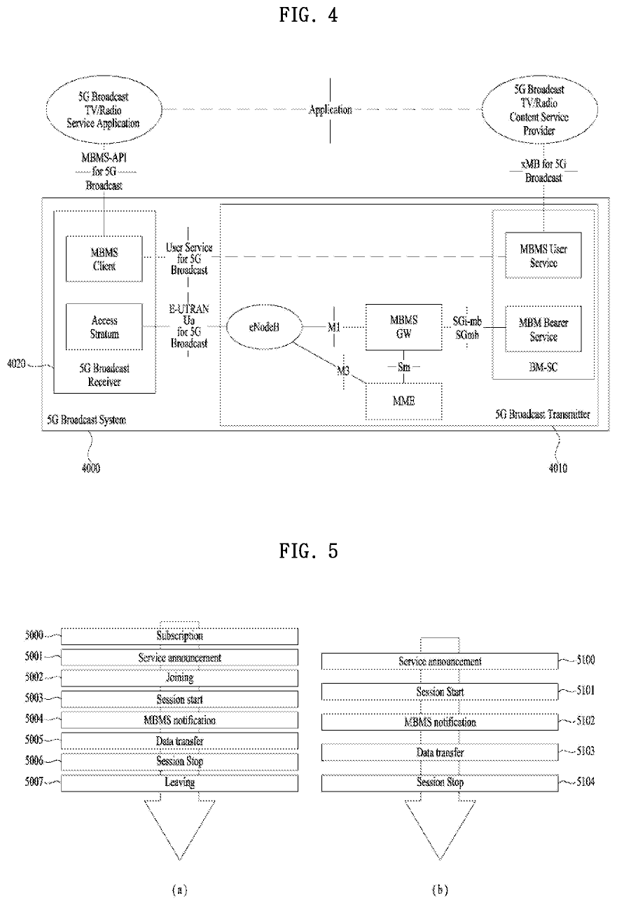

FIG. 4 illustrates a communication network broadcast transmission/reception model structure according to embodiments.

The media data processing method/device according to the embodiments may transmit and receive data through the communication network broadcast model as shown in FIG. 4 on the network of FIGS. 1 and 2 based on the layers of FIG. 3.

It may correspond to the media data processing device according to the embodiments of FIGS. 1, 2, 6, 8, 11, and 12.

### 4. MBMS Structure

FIG. 4 illustrates a network model of a 5G broadcast system for the media data processing method/device according to the embodiments.

In the 5G broadcast system according to embodiments, multiple users receive the same data at the same time and over the same link. Regardless of the number of eNodeBs or UEs to receive the multicast broadcast message, a common channel may be used to transmit the data to multiple users who can receive the same data even in the radio section.

To provide 5G broadcast MBMS service, an MBMS Gateway (GW) and a BM-SC are provided as network components, and the BM-SC is connected to the GGSN. It is also possible to connect to a conventional cell broadcast center (CBC) providing cell broadcast services and integrate the services.

The BM-SC according to embodiments may supply or deliver services. It may be for a content provider, and may enable control over MBMS transmissions and access to bearers, as well as coordinate scheduling and enable MBMS transmissions.

The SGmb interface according to embodiments may send and receive MBMS service-related signaling and user-related signaling between the MBMS GW and the BM-SC. For the MBMS service-related signaling, the MBMS GW may establish or terminate an MBMS bearer context, perform a series of registration and unregistration with the BM-SC, and deliver information such as appropriate QoS parameters from the BM-SC to the MBMS GW to open an MBMS service session. The user signaling authenticates a receiver requesting to join or participate in the multicast service at the BM-SC and acquires from the mobility management entity (MME) information about the receiver's participation in the current multicast session and billing information.

In FIG. 4, M1 is a reference point defined for MBMS data transmission between the MBMS GW and the E-UTRAN/UTRAN, and M3 is a reference point defined for data control in the MME and the E-UTRAN/UTRAN. Also, xMB is a reference point defined between the BM-SC and the TV/radio content provider.

As shown in FIG. 4, a communication network broadcast system 4000 that transmits data to a media data processing device according to embodiments may include a 5G broadcast transmitter 4010 and a 5G broadcast receiver 4020.

In the media data processing method/device according to the embodiments, the media data transmission method/device may correspond to the 5G broadcast transmitter 4010. In the media data processing method/device according to the embodiments, the media data reception method/device may correspond to the 5G broadcast receiver 4020.

The operation of the media data transmission method/device according to the embodiments and the operation of the media data reception method/device according to the embodiments may correspond to each other and may be described as a reverse process, complementing each other.

The 5G broadcast transmitter 4010 may refer to a processor or a system in which the content provider shown in FIGS. 1 and 2 transmits data to the receiver according to embodiments based on the network structure. In other words, the eNodeb may be connected to the MBMS GW and the MME based on the M1 and M3 interfaces, respectively. The MBMS GW and the MME may be connected by the Sm interface. The BM-SC may comply with the description of the BM-SC of FIGS. 1 and 2, etc. The 5G broadcast transmitter 4010 may be connected to the content service provider based on the xMB interface.

The 5G broadcast receiver 4020 may include an MBMS client and an access stratum. The access stratum may be connected to the eNodeB based on the E-UTRAN Uu interface for 5G broadcast. The MBMS client may be connected to the MBMS user service of the 5G broadcast transmitter based on the user service interface for 5G broadcast. The 5G broadcast receiver 4020 may be connected to a 5G broadcast TV/radio service application based on an MBMS API interface for 5G broadcast. At the application level, data may be transmitted to and from the 5G broadcast TV/radio content service provider for the 5G broadcast transmitter 4010.

The BM-SC may receive actual media data and meta-data from the content provider.

The BM-SC may initiate/terminate the media service by the MBMS provisioning system. The provided media data is processed into a container in a form suitable for the service and transmitted to the receiver based on a delivery method suitable for the media data container.

The receiver system corresponding to the transmitter system includes a modem layer and a service layer. The modem layer may receive the MBMS physical layer channel through a modem, and support simultaneous access to multiple MBMS services and unicast MBMS services. The service layer may include an MBMS client and an MBMS application. The MBMS client may receive meta-data such as USD and MPD for service announcement. The media data processing method/device according to the embodiments may utilize the corresponding information contained in the meta-data in the channel acquisition process. In order to transmit the actual media data, the media data transmission method/device according to the embodiments may perform a streaming service by collecting the media segments contained in the media container generated by the media format encoder for a certain period of time.

Furthermore, the media data transmission and reception method/device according to the embodiments may download a file and execute a service on a specific application using the file. It may also use a back channel to transmit information related to reception performance to the transmitter system.

FIG. 5 is a flowchart of MBMS multicast service provision and MBMS broadcast service provision according to embodiments.

In the network of FIGS. 1 and 2, the transmission and reception devices of FIG. 4 may perform MBMS multicast and/or broadcast in accordance with the flowchart of FIG. 5 through the layer structure of FIG. 3.

FIG. 5-(a) is a flowchart of MBMS multicast service provision, and FIG. 5-(b) is a flowchart of MBMS broadcast service provision.

### 5. MBMS Service Process

As shown in FIG. 5, the media data processing method/device according to embodiments may perform a series of procedures to initialize the MBMS multicast service. The MBMS multicast service is similar to the MBMS broadcast method, but requires three more operations: subscription, joining, and leaving. This is because the multicast method additionally requires a user registration process unlike the broadcast method. FIG. 5-(b) illustrates a series of procedures and operations for initializing the MBMS broadcast service.

The media data processing method/device according to the embodiments may perform the MBMS multicast service provision in the following order.

### 1) Subscription 5000

This is an operation of registering a user. The user may perform the procedure of receiving a basic registration key to receive the service. In the case of flat charging, the registration operation may be associated with the operation of initiating the charging. The user is registered with the server such as the BM-SC as a user who can receive the service through the subscription operation.

### 2) Service Announcement 5001

This is an operation of transmitting information about the service. It is an operation of transmitting, to users, information about a service that is currently being provided or will be provided in the future. Information about the ID (IP multicast address or APN address) of the service and the QoS of the service may be delivered to the users.

### 3) Joining 5002

A user's intention to receive the service may be delivered to the network. Specifically, the joining is an operation in which a user who has already been registered delivers the intention to receive the service to the network based on the service information received through the service announcement. It is an operation of delivering the ID of the service to the BM-SC such that the service may be received when the service starts or when the service has already started and the network may prepare for data transmission.

### 4) Session Start 5003

This is an operation of notifying that the data transfer of the service is ready to start when the data is to be transferred. The BM-SC transmits the MBMS Session Start message to notify that the data is ready to be transmitted and to configure a necessary bearer. The Session Start includes necessary QoS information.

### 5) MBMS Notification 5004

This is an operation of notifying each terminal of the Session Start.

### 6) Data Transfer 5005

This is an operation of transferring the actual data for the service.

### 7) Session Stop 5006

This operation is necessary when the transmission for the service is stopped. When the data transfer is stopped for more than a certain period of time, the BM-SC may transmit a Session Stop message to release the resource for efficient use of the entire resources. In addition, when there is new data, the BM-SC may transmit the Session Start to reallocate the necessary resources.

### 8) Leaving 5007

This is an operation performed when the user intends to stop receiving the service.

The media data processing method/device according to the embodiments may perform the service announcement, session start, notification, data transfer, and session stop based on the broadcast method.

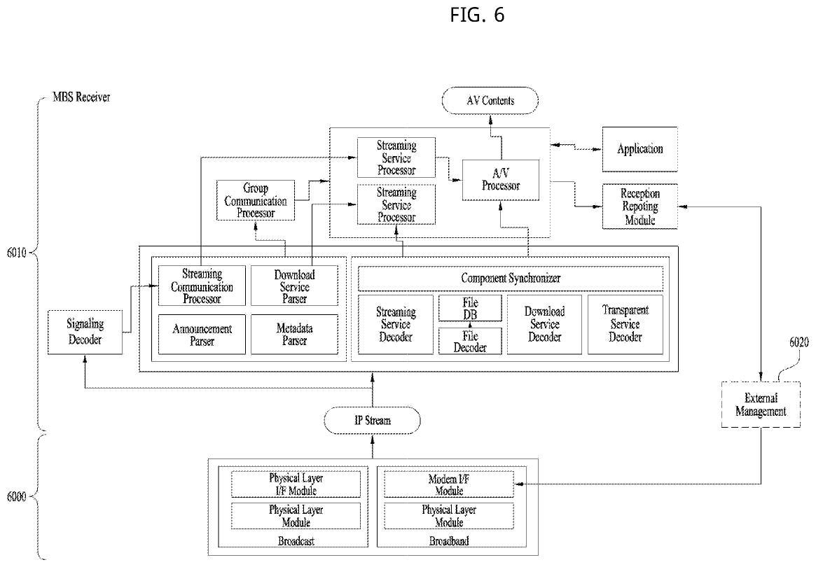

FIG. 6 illustrates a reception device structure of a communication network broadcast system according to embodiments.

In the network of FIGS. 1 and 2, through the layer structure as shown in FIG. 3, the transmission and reception devices of FIG. 4 may perform MBMS multicast and/or broadcast according to the flowchart as shown in FIG. 5, and the MBMS may be received by the media data processing device according to the embodiments as shown in FIG. 6.

The MBMS receiver of FIG. 6 may correspond to the MBMS receiver 1020 of FIGS. 1 and 2, the 5G broadcast receiver 4020 of FIG. 4, and the like.

It may correspond to the media data processing device according to the embodiments of FIGS. 1, 2, 8, 11, and 12.

The media data reception device according to the embodiments may include a 5G broadcast system receiver structure.

The reception device structure according to the embodiments may include a physical modem layer 6000 and a service layer 6010. The modem layer 6000 may receive MBMS physical layer channels through a modem to provide simultaneous access to multiple MBMS services and unicast MBMS services. The media data processing device according to the embodiments may receive broadband and broadcast wireless signals through the physical modem layer. Further, it may acquire an IP packet stream and forward the same to a service layer. The media data processing device according to the embodiments may receive actual announcement, signaling, and description information such as meta-data through the physical modem layer.

The signaling decoder of the media data processing device according to the embodiments may be delivered to a parser according to the corresponding type to perform provisioning based on the information contained in the metadata and perform a series of procedures to acquire the actual media data.

The MBMS provisioning system may initiate and terminate the media service. The media data reception method/device according to the embodiments may include the media data in the form of a container suitable for the service.

Based on the delivery method suitable for the media data container, the streaming service decoder, download service decoder, and the like of the media data reception method/device according to the embodiments may acquire the actual media data.

The streaming service processor and download service processor of the media data reception device according to the embodiments may play the actual AV data.

The service layer 6010 of the media data reception device according to the embodiments represents the operation of receiving meta-data such as USD and MPD for service announcement and acquiring channel information through the MBMS application and API.

The media data reception device according to the embodiments may provide A/V data based on the information contained in the meta-data.

To deliver the actual media data, the media data transmission device according to the embodiments may provide a streaming service by collecting the media segments or AUs contained in the media container generated by the streaming service encoder of the media data transmission device according to the embodiments for a certain period of time.

In addition, a file may be downloaded from the download service encoder of the media data transmission device according to the embodiments, and a specific application may execute the service using the file. Information related to reception performance may be reported to the transmitter system of the media data transmission device according to the embodiments using the back channel.

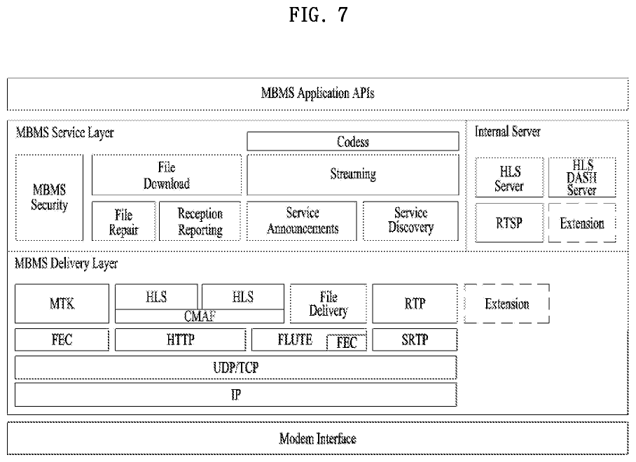

FIG. 7 illustrates a communication network broadcast protocol stack according to embodiments.

The media data transmission/reception method/device according to the embodiments of FIGS. 4 to 6 may conform to the protocol stack of FIG. 7.

To support the function of the MBMS streaming service according to the embodiments, operations related to the transmission of media segments and AUs may be performed at the MBMS delivery layer. The MBMS delivery layer according to the embodiments may be referred to by various terms.

According to embodiments, the MBMS service layer and the MBMS delivery layer may each be extended.

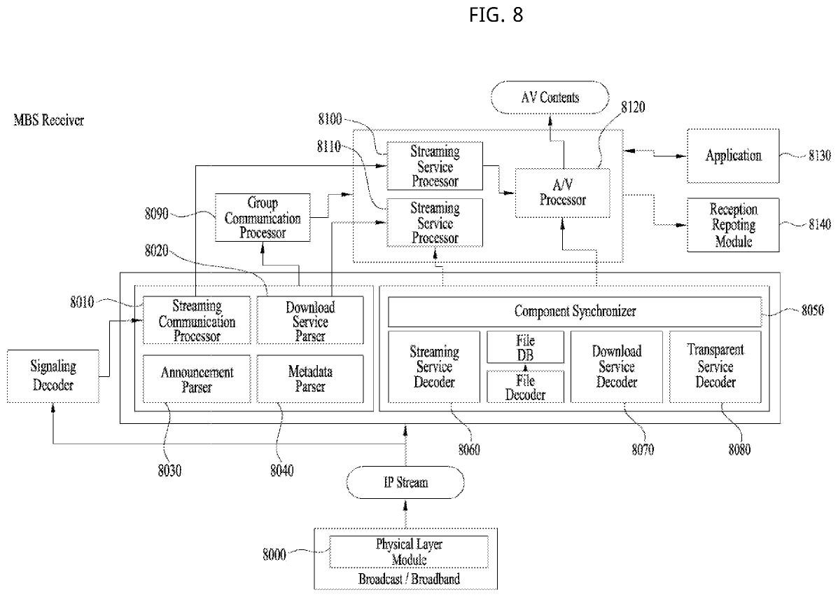

FIG. 8 illustrates an MBMS reception device of a communication network broadcast reception device according to embodiments.

FIG. 8 may correspond to the reception device of FIG. 6, and may correspond to the media data processing device according to embodiments. FIG. 8 may correspond to the media data processing device according to the embodiments of FIGS. 1, 2, 11, and 12.

A media data reception device according to embodiments may include the 5G broadcast system reception device of FIG. 8. For components in FIG. 8 that are common to FIG. 6, refer to the description of FIG. 6.

Embodiments may conform to a standard method. For example, delivery protocol, signaling, and media streaming terminals may meet both backward compatibility with existing standards and ease of porting according to new and additional implementations.

Furthermore, the entire system of the embodiments may include a parser, an encoder, and a processor for technical extensibility and universality. This structure enhances portability on new terminal platforms. That is, it facilitates portability by adding and modifying a predefined form of API.

The standard method according to the embodiments may support two modes of transmission, such as a broadcast path and a broadband path.

In the case of the broadband path, operations due to the addition of a new media player or modification of the function of an existing media player may be guaranteed.

To this end, the media data processing method/device according to the embodiments shown in FIG. 8 may further include a component synchronizer. The component synchronizer may minimize latency that may occur during the processing of delivering media contents to a media player. In other words, the component synchronizer may improve the synchronization performance of metadata for playback on a media player in a hybrid interconnection service received over a broadcast network and a communication network.

Each component of FIG. 8 may correspond to hardware, software, a processor, and/or a combination thereof. Each component of the 5G broadcast system is described below.

Physical Layer Module 8000: Receives wireless signals through terrestrial broadcasting and communication networks, performs processing to acquire IP datagrams from the frames, and provides the acquired IP datagrams to a higher layer.

Streaming Service Parser 8010: Acquires actual media packets related to the operation of the media streaming service from the IP datagrams or the like based on the information acquired from the physical layer module 8000.

Download Service Parser 8020: Acquires actual file packets related to file transfer service operation from the IP datagrams or the like.

Announcement Parser 8030: Extracts announcement and signaling information related to service scanning and service/content, etc. from the IP datagrams or the like.

Metadata Parser 8040: Extracts metadata information related to service scanning and service/content, etc. from the IP datagrams or the like.

Component Synchronizer 8050: May perform content and service synchronization based on the data decoded through a streaming service decoder 8060, a file decoder, and a download service decoder. It my perform AV rate control and monitoring to allow the data to be delivered to the media player in synchronization with the IP-based AV data received from the tuner/baseband and IP broadband.

The synchronizer according to the embodiments may perform synchronization between data transmitted over two physically different networks, received over a broadcast network (tuner) and a communication network (broadband LTE/5G), respectively.

For example, the types of data may include manifests and media segments. Further, the synchronizer according to the embodiments may further include synchronization between different media formats, even if data are transmitted over the same communication network (broadband LTE/5G).

The signaling decoder may acquire and parse the entire signaling information (USD, SDP, MDP), and the information may be parsed by a corresponding parser 8010, 8020, 8030, 8040 categorized by each feature according to the parsing result.

Streaming Service Decoder 8060: Decodes audio/video data for real-time A/V streaming from IP datagrams or the like.

Download Service Decoder 8070: Downloads and decodes a file acquired from the IP datagrams or the like.

Transparent Service Decoder 8080: Extracts data in the form of files such as non real time (NRT) data and applications from the IP datagrams or the like and decodes the data.

Group Communication Processor 8090: Controls the receiver operation to acquire media content and other data on a broadband channel based on subscription information about a user for a multicast service.

Streaming Service Processor 8100: Operates a receiver media player for playing media content.

Download Processor 8110: Outputs or utilizes a file to control operations in connection with the receiver application.

A/V Processor 8120: May render audio/video based on decoded audio and video data, application data, etc. It receives audio/video data from the AV player interface and controls a real AV codec to output the AV video to the real screen.

Application 8130: Processes application-related information, downloaded application status and display parameters, processes API and event messages with the application, and controls the behavior of all frames consistently.

Reception Reporting Module 8140: Transmits reception information to be acquired by the service provider when the receiver does not receive the wireless signal directly or for performance improvement.

External Management 6020: May refer to modules external to the broadcast receiver for providing broadcast services/content, such as a next generation broadcast service/content server.

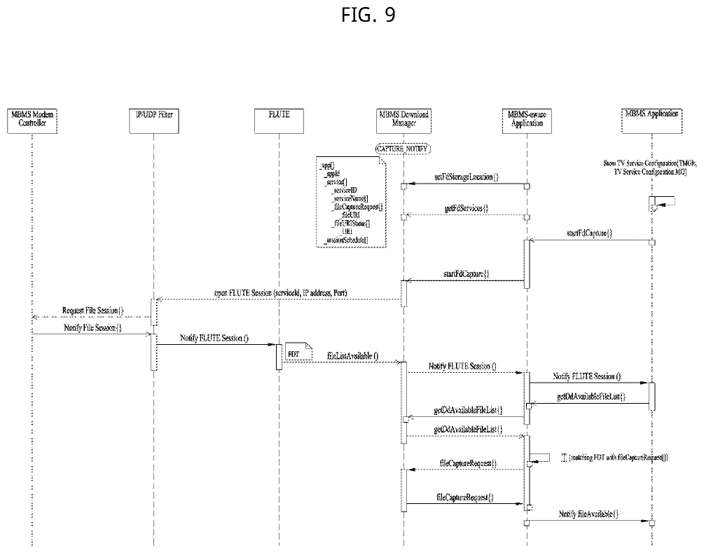

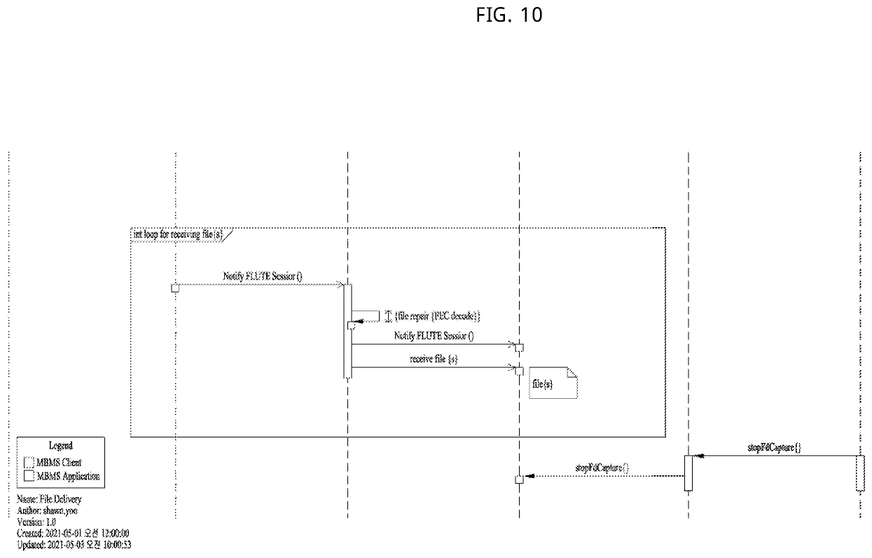

FIGS. 9 and 10 illustrate an MBMS file delivery workflow of a communication network broadcast receiver according to embodiments.

The media data processing device according to the embodiments of FIGS. 1, 2, 4, 6 to 8, and the like may perform the operations illustrated in FIGS. 9 and 10.

The MBMS client of FIGS. 9 and 10 may correspond to the media data processing device according to the embodiments, and the MBMS application of FIGS. 9 and 10 may refer to a higher layer of the media data processing device according to the embodiments, for example, the application layer.

The media data processing device according to the embodiments may perform the operations of FIGS. 9 and 10 to receive file information about the service data.

The session for receiving the file may be a FLUTE session. In order to receive a file through the FULTE session, session information may be acquired. The session information may include service identification information, IP address information, and port information.

Based on the received session information, the file(s) may be downloaded.

The media data processing device according to the embodiments may decode the file(s) and provide service data (e.g., audio/video data) based on the file(s).

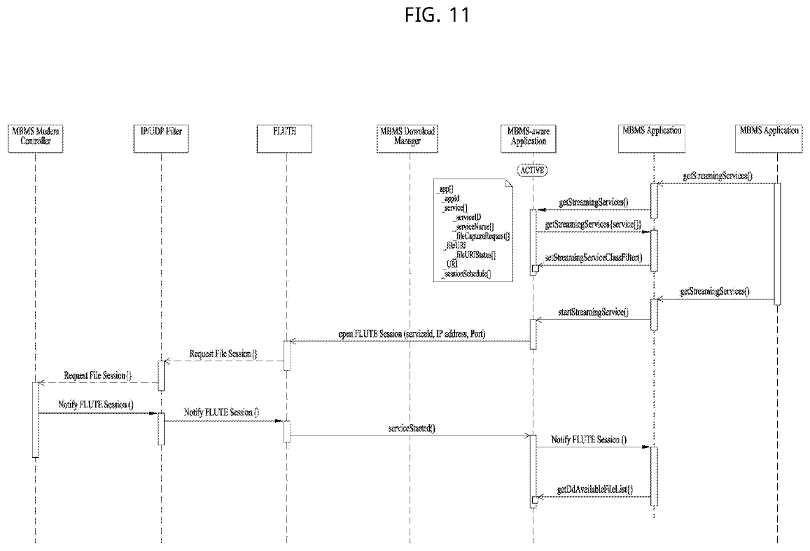

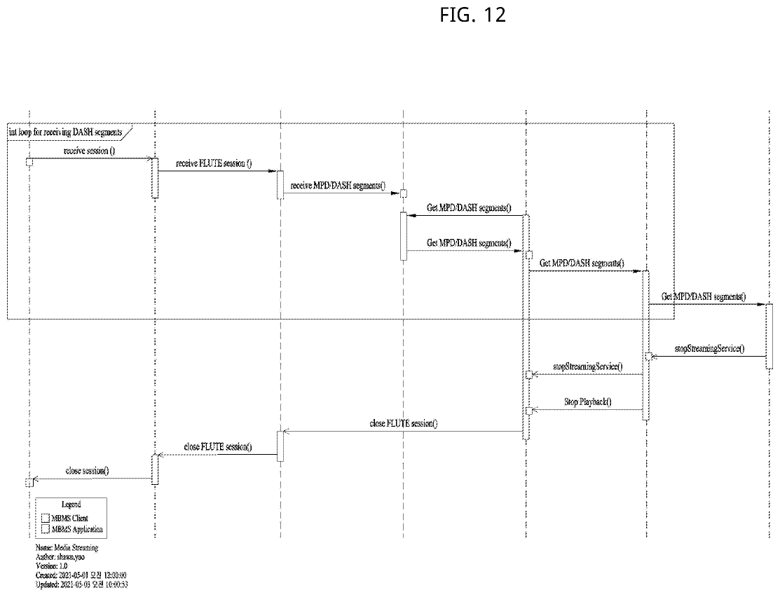

FIGS. 11 and 12 illustrate an MBMS media streaming workflow of a communication network broadcast receiver according to embodiments.

The media data processing device according to the embodiments of FIGS. 1, 2, 4, 6 to 8, and the like may perform the operations illustrated in FIGS. 11 and 12.

The MBMS client of FIGS. 11 and 12 may correspond to the media data processing device according to the embodiments, and the MBMS application of FIGS. 11 and 12 may refer to a higher layer of the media data processing device according to the embodiments, for example, the application layer.

The media data processing device according to the embodiments may perform the operations of FIG. 10 to stream the service data.

The session for streaming the service data may be a FLUTE session.

The media data processing device according to the embodiments may receive a DASH segment based on the FLUTE session.

The media data processing device according to the embodiments may receive information, such as a decoded MPD, from the signaling decoder to acquire signaling information about the DASH segment.

The media data processing device according to the embodiments may provide service data included in the DASH segment based on the MPD or the like.

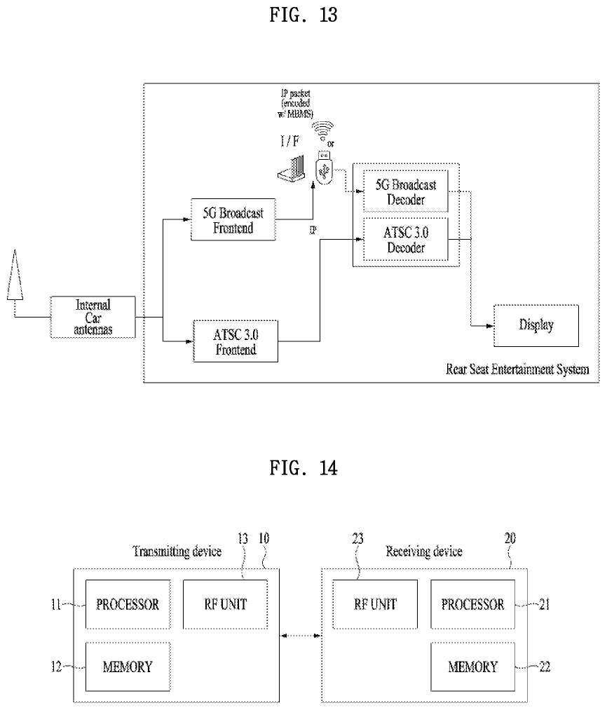

FIG. 13 illustrates how a network broadcast receiver operates according to embodiments.

FIG. 13 may correspond to the media data processing device according to the embodiments of FIGS. 1, 2, 4, 6 to 8, and the like. FIG. 13 may be an example of an application to an in-vehicle device. FIG. 13 may also be applied to a television receiver.

The receiver of a 5G broadcast system according to the embodiments may be implemented as an in-vehicle entertainment system. FIG. 13 illustrates a method of configuring a component. An in-vehicle entertainment system according to embodiments may be configured as shown in FIG. 13 as a hybrid of the 5G broadcast standard and ATSC3.0, which is the next generation terrestrial UHD standard. Therefore, the wireless signals received from the antenna are distinguished as to whether they are for processing at the 5G broadcast front-end or for processing at the ATSC3.0 front-end and delivered to the corresponding decoder to be processed by the 5G broadcast decoder and the ATSC3.0 decoder, respectively.

The in-vehicle entertainment system will be configured to provide various services not only through the traditional broadcast network, but also through the combination with the Internet and communication network. In other words, receivers capable of using only the Internet and communication network (e.g., smartphones, vehicles, etc.) will be allowed to receive services through a terrestrial broadcast network if they are equipped with a broadcast reception chip. Therefore, various data types and forms, including media, that can be received by the next-generation in-vehicle entertainment system may be flexibly processed through a broadcast or communication network, and thus an application provided by the service provider as well as metadata and data (e.g., images, icons, etc.) used by the application may be received, thereby enabling seamless media services and file transfer services in a mobile environment.

In the case of video, the video may be downloaded through the broadcast network and the displayed on the screen, or may be played using a real-time streaming method. In this case, where there is a local storage provided to store received data, the service may be provided to various second devices through in-vehicle retransmission.

FIG. 14 illustrates a structure of a media data transmission/reception device according to embodiments.

The device of FIG. 14 may correspond to the media data processing device according to the embodiments of FIGS. 1, 2, 4, 6 to 8, 13, and the like.

FIG. 14 is a block diagram illustrating components of a transmission device 10 and a reception device 20 for carrying out an embodiment of the present disclosure.

The transmission device 10 and reception device 20 each include a radio frequency (RF) unit 13, 23 configured to transmit or receive radio signals carrying information and/or data, signals and messages, and a memory 12, 22 for various kinds of storage. A processor 11, 21 operatively coupled to communication-related information and components including the RF unit 13, 23 and the memory 12, 22 in a wireless communication system and configured to control the memory 12, 22 and/or the RF unit 13 is provided to carry out at least one of the embodiments of the present disclosure.

The memory 12, 22 may store programs for processing and controlling the processor 11, 21, and may temporarily store input and output signals. The memory 12, 22 may be used as a buffer.

The processors 11 and 21 generally control the entire operations of the various modules of the transmission device and the reception device. In particular, the processors 11 and 21 may perform various control functions to carry out the present invention. The processors 11 and 21 may be referred to as controllers, microcontrollers, microprocessors, microcomputers, or the like.

The processors 11 and 21 may be implemented by a variety of means, including hardware, firmware, software, or a combination thereof. When implementing embodiments in hardware, the processor 11, 21 may include an application specific integrated circuit (ASIC), a digital signal processor (DSP), a digital signal processing device (DSPD), a programmable logic device (PLD), and a field programmable gate array (FPGA) configured to perform embodiments of the present disclosure. When the operations or functions of an embodiment are implemented in firmware or software, the firmware or software may perform the functions or operations of the module, procedure, or embodiments. The firmware or software configured to perform the embodiments may be included in the processor 11, 21 or may be stored in the memory 12, 22 and operated by the processor 11, 21.

The processor 11 of the transmission device 10 codes and modulates signals and/or data scheduled to be transmitted to an external device by the processor 11 or a scheduler connected to the processor 11, and transmits the signals. It also transmits the data to the RF unit 13.

For example, the processor 11 transforms the data stream to be transmitted to the K-layer through demultiplexing, channel coding, scrambling, modulation, and the like. The coded data stream may represent a codeword.

A transport block, which is a data block provided by the medium access control (MAC) layer. One transport block (TB) is encoded with one codeword, and each codeword is transmitted to the receiver in the form of one or more layers. For frequency up-conversion, the RF unit 13 may include an oscillator. The RF unit 13 may include Nt transmission antennas (where Nt is a positive integer).

The signal processing by the reception device 20 may follow a reverse process to the signal processing by the transmission device 10. Under the control of the processor 21, the RF unit 23 of the reception device 20 receives a radio signal transmitted by the transmission device 10. The RF unit 23 may include Nr reception antennas (where Nr is a positive integer). The RF unit 23 performs frequency down-conversion on each signal received through each reception antenna and restores the baseband signal.

The RF unit 23 may include an oscillator for frequency down-conversion. The processor 21 may decode and demodulate the radio signals received through the reception antennas and reconstruct the source data transmitted by the transmission device 10.

Each of the RF units 13 and 23 includes one or more antennas. The antennas serve to transmit signals processed by the RF units 13 and 23 to an external device, to receive radio signals from an external device, and to transmit the radio signals to the RF units 13 and 23 under the control of the processors 11 and 21.

The antennas according to the embodiments may also be referred to as antenna ports. Each antenna may be composed of a single physical antenna or a combination of two or more physical antenna elements. The signal transmitted through each antenna is not decomposed at the reception device 20. A reference signal (RS) that is transmitted according to the antenna defines the antenna from the perspective of the reception device 20 and allows the reception device 20 to perform channel estimation. It may be irrelevant to whether the channel is a single radio channel from a single physical antenna or a synthesized channel from a plurality of physical antenna elements including the antenna. In other words, the antenna is defined such that a channel for transmitting a symbol through the antenna is derived from a channel for transmitting another symbol through the same antenna. In the case of an RF unit that supports the multiple input multiple output (MIMO) function, which uses multiple antennas to transmit and receive data, two or more antennas may be connected.

A UE according to embodiments operates as the transmission device 10 on the uplink and as the reception device 20 on the downlink. An eNB according to embodiments operates as the reception device 20 on the uplink and as the transmission device 10 on the downlink. The processor, RF unit, and memory included in the UE are referred to as a UE processor, UE RF unit, and UE memory, respectively. The processor, RF unit, and memory included in the eNB are referred to as an eNB processor, eNB RF unit, and eNB memory, respectively.

A detailed description of exemplary embodiments has been provided to enable those skilled in the art to implement and practice the embodiments. Although the embodiments have been described with reference to exemplary embodiments, those skilled in the art will appreciate that various modifications and variations can be made to the present disclosure without departing from the spirit or scope of the disclosure as set forth in the appended claims. Accordingly, the present disclosure should not be limited to specific embodiments described herein, but should be viewed in the broadest sense consistent with the principles and novel features disclosed herein.

In addition to wireless communication systems for providing IoT services based on LTE systems, embodiments may be applied to various wireless systems that support narrowband communications for providing IoT services.

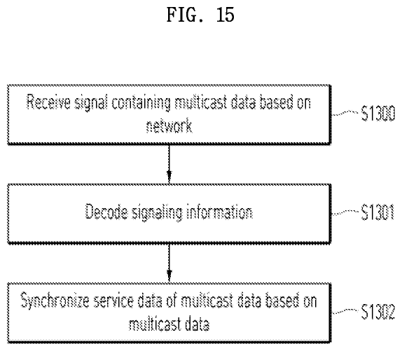

FIG. 15 illustrates a media data processing method according to embodiments.

A media data processing device according to embodiments, for example, the device of FIGS. 1, 2, 4, 6, 8, 13, 14, and the like, may process media data based on the following flowchart.

The method of processing media data according to embodiments may include receiving a signal containing multicast data based on a network (S1300).

The receiving operation according to the embodiments may be performed based on the network structure of FIGS. 1 and 2 and the layer structure of FIG. 3. Data may be sent and received between the transmitter and the receiver as shown in FIG. 4. The receiving operation may conform to the method of FIG. 5. It may include in-vehicle reception in a hybrid form between a broadcast network and a communication network, as shown in FIG. 13.

The network according to embodiments may include an Internet Protocol (IP) network, and the signal may include a packet containing multicast data, wherein the packet may include signaling information related to the multicast data.

The method of processing media data according to the embodiments may further include decoding the signaling information (S1301).

As shown in FIGS. 6 to 8, the decoding of the signaling information may include parsing multicast data, parsing a file from the packet, and parsing announcement information related to the multicast data from the packet. Based on service data and signaling information about the service data, media data may be provided.

As shown in FIGS. 9 to 12, the file and media streaming may be parsed.

The method of processing media data according to the embodiments may further include synchronizing the service data of the multicast data based on the multicast data.

The synchronizing may include synchronizing the service data of the multicast data based on the multicast data and the file.

A media data processing device according to embodiments may include a receiver configured to receive a signal containing multicast data based on a network, wherein the network may include an Internet Protocol (IP) network, and the signal may contain a packet containing the multicast data. Further, the packet may contain signaling information related to the multicast data. The device may further include a signaling decoder configured to decode the signaling information, a streaming service parser configured to parse the multicast data, a download service parser configured to parse a file from the packet, a parser configured to parse announcement information related to the multicast data from the packet, and a component synchronizer configured to synchronize service data of the multicast data based on the multicast data and the file.

The multicast data according to the embodiments may be received based on at least one of a multicast mode or a broadcast mode. In the multicast mode, the data may be delivered to a specific receiver. In the broadcast mode, the data may be delivered to all receivers belonging to one network.

The network according to the embodiments may include a multicast broadcast gateway and a broadcast service center. The multicast mode may include registering a user for data reception, receiving service information for the data reception, and joining a multicast network, and the broadcast mode may include receiving service information for the data reception.

The signal according to the embodiments may contain metadata for the service information based on the multicast broadcast layer.

Accordingly, embodiments may allow for the transmission of high definition media content. Embodiments may handle real-time live broadcasting. Embodiments may integrate high-definition mobile broadcast and communication technologies. Embodiments may provide in-vehicle video/audio entertainment channels and data information services. Embodiments may provide technologies for interworking with 5G core infrastructure. Embodiments may handle multi-path streaming services. Embodiments may optimize the video delivery path.

The embodiments have been described in terms of a method and/or a device, and the description of the method and the description of the device may be applied complementary to each other.

Although the accompanying drawings have been described separately for simplicity, it is possible to design new embodiments by combining the embodiments illustrated in the respective drawings. Designing a recording medium readable by a computer on which programs for executing the above-described embodiments are recorded as needed by those skilled in the art also falls within the scope of the appended claims and their equivalents. The devices and methods according to embodiments may not be limited by the configurations and methods of the embodiments described above. Various modifications can be made to the embodiments by selectively combining all or some of the embodiments. Although preferred embodiments have been described with reference to the drawings, those skilled in the art will appreciate that various modifications and variations may be made in the embodiments without departing from the spirit or scope of the disclosure described in the appended claims. Such modifications are not to be understood individually from the technical idea or perspective of the embodiments.

Various elements of the devices of the embodiments may be implemented by hardware, software, firmware, or a combination thereof. Various elements in the embodiments may be implemented by a single chip, for example, a single hardware circuit. According to embodiments, the components according to the embodiments may be implemented as separate chips, respectively. According to embodiments, at least one or more of the components of the device according to the embodiments may include one or more processors capable of executing one or more programs. The one or more programs may perform any one or more of the operations/methods according to the embodiments or include instructions for performing the same. Executable instructions for performing the method/operations of the device according to the embodiments may be stored in a non-transitory CRM or other computer program products configured to be executed by one or more processors, or may be stored in a transitory CRM or other computer program products configured to be executed by one or more processors. In addition, the memory according to the embodiments may be used as a concept covering not only volatile memories (e.g., RAM) but also nonvolatile memories, flash memories, and PROMs. In addition, it may also be implemented in the form of a carrier wave, such as transmission over the Internet. In addition, the processor-readable recording medium may be distributed to computer systems connected over a network such that the processor-readable code may be stored and executed in a distributed fashion.

In the present disclosure, “/” and “,” should be interpreted as indicating “and/or.” For instance, the expression “A/B” may mean “A and/or B.” Further, “A, B” may mean “A and/or B.” Further, “A/B/C” may mean “at least one of A, B, and/or C.” Also, “A/B/C” may mean “at least one of A, B, and/or C.” Further, in this specification, the term “or” should be interpreted as indicating “and/or.” For instance, the expression “A or B” may mean 1) only A, 2) only B, or 3) both A and B. In other words, the term “or” used in this document should be interpreted as indicating “additionally or alternatively.”

Terms such as first and second may be used to describe various elements of the embodiments. However, various components according to the embodiments should not be limited by the above terms. These terms are only used to distinguish one element from another. For example, a first user input signal may be referred to as a second user input signal. Similarly, the second user input signal may be referred to as a first user input signal. Use of these terms should be construed as not departing from the scope of the various embodiments. The first user input signal and the second user input signal are both user input signals, but do not mean the same user input signals unless context clearly dictates otherwise.

The terms used to describe the embodiments are used for the purpose of describing specific embodiments, and are not intended to limit the embodiments. As used in the description of the embodiments and in the claims, the singular forms “a”, “an”, and “the” include plural referents unless the context clearly dictates otherwise. The expression “and/or” is used to include all possible combinations of terms. The terms such as “includes” or “has” are intended to indicate existence of figures, numbers, steps, elements, and/or components and should be understood as not precluding possibility of existence of additional existence of figures, numbers, steps, elements, and/or components. As used herein, conditional expressions such as “if” and “when” are not limited to an optional case and are intended to perform the related operation or interpret the related definition according to a specific condition when the specific condition is satisfied.

Operations according to the embodiments described in this specification may be performed by a transmission/reception device including a memory and/or a processor according to embodiments. The memory may store programs for processing/controlling the operations according to the embodiments, and the processor may control various operations described in this specification. The processor may be referred to as a controller or the like. In embodiments, operations may be performed by firmware, software, and/or combinations thereof. The firmware, software, and/or combinations thereof may be stored in the processor or the memory.

The operations according to the above-described embodiments may be performed by the transmission device and/or the reception device according to the embodiments. The transmission/reception device may include a transmitter/receiver configured to transmit and receive media data, a memory configured to store instructions (program code, algorithms, flowcharts and/or data) for the processes according to the embodiments, and a processor configured to control the operations of the transmission/reception device.

The processor may be referred to as a controller or the like, and may correspond to, for example, hardware, software, and/or a combination thereof. The operations according to the above-described embodiments may be performed by the processor. In addition, the processor may be implemented as an encoder/decoder for the operations of the above-described embodiments.

### MODE FOR DISCLOSURE

As described above, related details have been described in the best mode for carrying out the embodiments.

### INDUSTRIAL APPLICABILITY

As described above, the embodiments are fully or partially applicable to a point cloud data transmission/reception device and system.

Those skilled in the art may change or modify the embodiments in various ways within the scope of the embodiments.

Embodiments may include variations/modifications within the scope of the claims and their equivalents.

What is claimed is:

1. A device for processing media data, the device comprising:
a receiver configured to receive a signal containing multicast data based on a network, wherein:
the network comprises an Internet Protocol (IP) network; and
the signal contains a packet containing the multicast data, the packet containing signaling information related to the multicast data;
a signaling decoder configured to decode the signaling information;
a streaming service parser configured to parse the multicast data;
a download service parser configured to parse a file from the packet;
a parser configured to parse announcement information related to the multicast data from the packet; and
a component synchronizer configured to synchronize service data of the multicast data based on the multicast data and the file.

2. The device of claim 1, wherein the multicast data is received based on at least one of a multicast mode or a broadcast mode,
wherein:
the multicast mode delivers data to a specific receiver; and
the broadcast mode delivers data to all receivers belonging to one network.

3. The device of claim 1, wherein the network comprises a multicast broadcast gateway and a broadcast service center.

4. The device of claim 2, wherein the multicast mode comprises:
registering a user for data reception;
receiving service information for the data reception; and
joining a multicast network,
wherein the broadcast mode comprises:
receiving service information for the data reception.

5. The device of claim 1, wherein the signal contains metadata for service information based on a multicast broadcast layer.

6. A method of processing media data, the method comprising:
receiving a signal containing multicast data based on a network, wherein:
the network comprises an Internet Protocol (IP) network; and
the signal contains a packet containing the multicast data, the packet containing signaling information related to the multicast data;
decoding the signaling information;
parsing the multicast data;
parsing a file from the packet;
parsing announcement information related to the multicast data from the packet; and
synchronizing service data of the multicast data based on the multicast data and the file.

7. The method of claim 6, wherein the multicast data is received based on at least one of a multicast mode or a broadcast mode,
wherein:
the multicast mode delivers data to a specific receiver; and
the broadcast mode delivers data to all receivers belonging to one network.

8. The method of claim 6, wherein the network comprises a multicast broadcast gateway and a broadcast service center.

9. The method of claim 7, wherein the multicast mode comprises:
registering a user for data reception;
receiving service information for the data reception; and
joining a multicast network,
wherein the broadcast mode comprises:
receiving service information for the data reception.

10. The method of claim 6, wherein the signal contains metadata for service information based on a multicast broadcast layer.
